(19) United States
(12) Patent Application Publication
(10) Pub. No.: US 2025/0247886 A1
(43) Pub. Date: Jul. 31, 2025

(54) COORDINATED TDMA CONSIDERING CHANNEL UTILIZATION

(71) Applicant: Senscomm Semiconductor Co., Ltd., Suzhou (CN)

(72) Inventors: Sung Jin PARK, Seoul (KR); Daehong KIM, Laguna Hills, CA (US)

(21) Appl. No.: 19/040,774

(22) Filed: Jan. 29, 2025

Related U.S. Application Data
(60) Provisional application No. 63/626,451, filed on Jan. 29, 2024.
(60) Provisional application No. 63/550,906, filed on Feb. 7, 2024.
(60) Provisional application No. 63/740,286, filed on Dec. 30, 2024.

(30) Foreign Application Priority Data
Jan. 22, 2025 (CN) 202510103445.0

(51) Int. Cl. H04W 74/0816; H04W 74/00; H04W 76/14

(52) U.S. Cl. CPC H04W 74/0816; H04W 74/002; H04W 76/14

(57) ABSTRACT

A wireless communication device receives from a sharing access point (AP) station, a transmission opportunity (TXOP) allocation frame. The TXOP allocation frame includes information indicating a first shared duration of a TXOP and one or more first shared channels which the sharing AP station allocates to the wireless communication device. The first shared duration of the TXOP is within a duration of the TXOP acquired by the sharing AP station. The one or more first shared channels are a subset of a plurality of channels for which the sharing AP station acquired the TXOP. The wireless communication device performs wireless communication using the one or more first shared channels in the first shared duration of the TXOP.

### CROSS-REFERENCE TO RELATED APPLICATIONS

This application claims the benefit of priority from U.S. Provisional Application No. 63/626,451, filed Jan. 29, 2024, U.S. Provisional Application No. 63/550,906, filed Feb. 7, 2024, and U.S. Provisional Application No. 63/740,286, filed Dec. 30, 2024, which claims priority to Chinese Patent Application No. 202510103445.0 filed in the China National Intellectual Property Administration on Jan. 22, 2025, the entire contents of which are hereby incorporated by reference.

### TECHNICAL FIELD

The disclosure relates to wireless communication systems, and more particularly to, for example, but not limited to, a coordinated TDMA considering channel utilization.

### BACKGROUND

The Wi-Fi system has a transmission opportunity (TXOP) sharing framework. The TXOP sharing may allow an access point (AP) station (STA) to allocate time within an obtained TXOP to an associated non-AP STA. The non-AP STA to which time is allocated by the AP may transmit uplink (UL) data without receiving a trigger frame from the AP and may communicate peer-to-peer with other non-AP STAs within the same basic service set (BSS).

However, since the existing TXOP sharing enables the AP to allocate time resources to only one STA, it can limit traffic throughput. Moreover, it is inefficient in terms of channel utilization as it only allocates time without considering the available frequency resources.

The description set forth in the background section should not be assumed to be prior art merely because it is set forth in the background section. The background section may describe aspects or embodiments of the present disclosure.

### SUMMARY

Some aspects of this disclosure are directed to improvements to TXOP sharing framework.

In some embodiments, a wireless communication device for facilitating wireless communication, comprises processing circuitry configured to cause: receiving, from a sharing access point (AP) station, a transmission opportunity (TXOP) allocation frame including information indicating a first shared duration of a TXOP and one or more first shared channels which the sharing AP station allocates to the wireless communication device, wherein the first shared duration of the TXOP is within a duration of the TXOP acquired by the sharing AP station and the one or more first shared channels are a subset of a plurality of channels for which the sharing AP station acquired the TXOP; and performing wireless communication using the one or more first shared channels in the first shared duration of the TXOP.

In some embodiments, the TXOP allocation frame further includes information indicating a second shared duration of the TXOP and one or more second shared channels which the sharing AP station allocates to another wireless communication device, wherein the second shared duration of the TXOP is the same as the first shared duration of the TXOP and the one or more second shared channels are not overlapped with the one or more first shared channels.

In some embodiments, the wireless communication device is a non-AP station which is associated with the sharing AP station, and the another wireless communication device is an AP station.

In some embodiments, the wireless communication device is an AP station, and the another wireless communication device is a non-AP station which is associated with the sharing AP station.

In some embodiments, the wireless communication device is a first non-AP station which is associated with the sharing AP station, and the another wireless communication device is a second non-AP station which is associated with the sharing AP station.

In some embodiments, the wireless communication device is a first AP station, and the another wireless communication device is a second AP station.

In some embodiments, the processing circuitry is further configured to cause: transmitting a response frame in response to the TXOP allocation frame using the one or more first shared channels.

In some embodiments, the processing circuitry is further configured to cause: receiving a control frame, wherein the control frame is transmitted through the plurality of channels by the sharing AP station after the sharing AP station acquires the TXOP; determining one or more idle channels among the plurality of channels; and transmitting a response frame through the one or more idle channels in response to the control frame, wherein the one or more first shared channels is all or a subset of the one or more idle channels.

In some embodiments, the response frame includes buffer status information of the wireless communication device.

In some embodiments, multi-user request to send (MU-RTS) frames are transmitted on duplicate mode through the plurality of channels as the control frame, and the clear to send (CTS) frame is transmitted on duplicate mode through the one or more idle channels as the response frame.

In some embodiments, the processing circuitry is further configured to cause: transmitting, to the sharing AP station, a frame to return the first shared duration of the TXOP and the one or more first shared channels.

In some embodiments, the wireless communication device is a non-AP station, and wherein performing the wireless communication comprises: performing wireless communication with the sharing AP station using the one or more first shared channels in the first shared duration of the TXOP.

In some embodiments, the wireless communication device is an AP station, and wherein performing the wireless communication comprises: performing wireless communication with one or more associated non-AP stations using the one or more first shared channels in the first shared duration of the TXOP.

In some embodiments, the wireless communication device is a non-AP station, and wherein performing the wireless communication comprises: performing peer-to-peer wireless communication with one or more non-AP stations using the one or more first shared channels in the first shared duration of the TXOP.

In some embodiments, an access point (AP) station for facilitating wireless communication, comprising processing circuitry configured to cause: acquiring a transmission opportunity (TXOP) for a plurality of channels; and transmitting a TXOP allocation frame including information indicating a first shared duration of the TXOP and one or more first shared channels which the AP station allocates to a first wireless communication device, wherein the first shared duration of the TXOP is within a duration of the TXOP acquired by the AP station and the one or more first shared channels are a subset of the plurality of channels for which the AP station acquired the TXOP, wherein the TXOP allocation frame enables the first wireless communication device to perform wireless communication using the one or more first shared channels in the first shared duration of the TXOP.

In some embodiments, the TXOP allocation frame further includes information indicating a second shared duration of the TXOP and one or more second shared channels which the AP station allocates to a second wireless communication device, wherein the second shared duration of the TXOP is the same as the first shared duration of the TXOP and the one or more second shared channels are not overlapped with the one or more first shared channels.

In some embodiments, the processing circuitry is further configured to cause: receiving, from the first wireless communication device, a response frame in response to the TXOP allocation frame using the one or more first shared channels.

In some embodiments, the processing circuitry is further configured to cause: transmitting a control frame through the plurality of channels by the AP station after the AP station acquires the TXOP; and receiving a response frame from the first wireless communication device through one or more idle channels of the first wireless communication device in response to the control frame, wherein the one or more first shared channels is all or a subset of the one or more idle channels.

In some embodiments, the response frame includes buffer status information of the wireless communication device.

In some embodiments, multi-user request to send (MU-RTS) frames are transmitted on duplicate mode through the plurality of channels as the control frame, and the clear to send (CTS) frame is transmitted on duplicate mode through the one or more idle channels as the response frame.

In some embodiments, wherein the processing circuitry is further configured to cause: receiving a frame from the first wireless communication device to return the first shared duration of the TXOP and the one or more first shared channels.

In some embodiments, the first wireless communication device is another AP station.

In some embodiments for the Wi-Fi network, multiple APs may cooperate with each other to transmit and receive data with STAs concurrently. Some aspects of this disclosure are directed to improvements to existing TXOP sharing framework for multiple APs coordination by allocating TXOP not only to the STA but also to neighboring APs using the same operating channels as a specific AP obtaining the TXOP uses.

Some embodiments can provide load balancing and latency reduction by assigning non-overlapping channels to a plurality of wireless communication devices.

Some embodiments can prevent interference caused by hidden nodes of a sharing AP by transmitting a response frame in response to a frame for allocating a TXOP.

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4A illustrates the EHT MU PPDU format in accordance with an embodiment.

FIG. 4B illustrates the EHT TB PPDU format in accordance with an embodiment.

FIG. 5 is a block diagram of an electronic device for facilitating wireless communication in accordance with an embodiment.

FIG. 6 shows a block diagram of a transmitter in accordance with an embodiment.

FIG. 7 shows a block diagram of a receiver in accordance with an embodiment.

FIG. 8 shows a network topology in accordance with an embodiment.

FIG. 9 shows a network topology in accordance with an embodiment.

FIG. 10 shows a TXOP sharing procedure in accordance with an embodiment.

FIG. 11 shows a TXOP sharing procedure in accordance with an embodiment.

FIG. 12 shows a TXOP sharing procedure in accordance with an embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

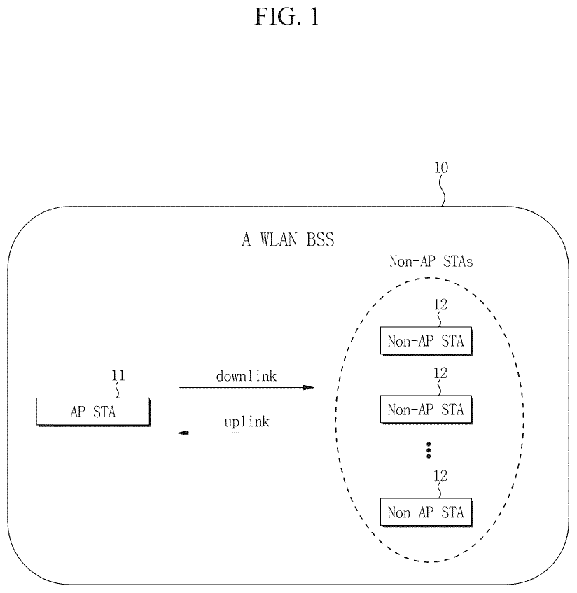

FIG. 1 illustrates a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in some embodiments, the AP STA and the non-AP STA may be referred as AP and STA, respectively. In some embodiments, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

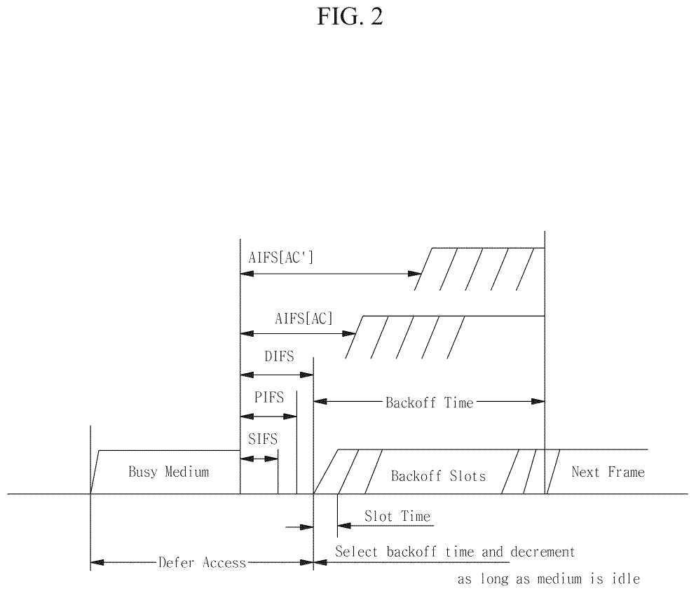

FIG. 2 illustrates an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QOS) STA may transmit the frame after performing backoff if an arbitration IFS (AIFS) for access category (AC), i.e., AIFS [AC] has elapsed. In this case, the data frame, the management frame, or the control frame which is not the response frame may use the AIFC [AC].

In some embodiments, a point coordination function (PCF) enabled AP STA may transmit the frame after performing backoff if a PCF IFS (PIFS) has elapsed. The PIFS duration may be less than the DIFS but greater than the SIFS.

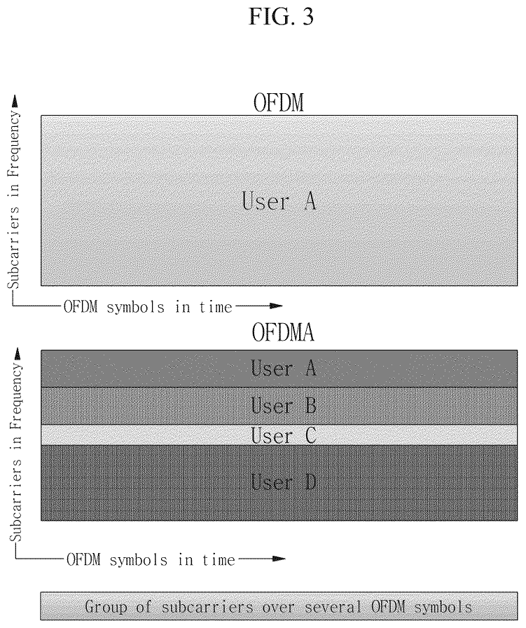

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA's information and assign RUs and multiple RUS (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

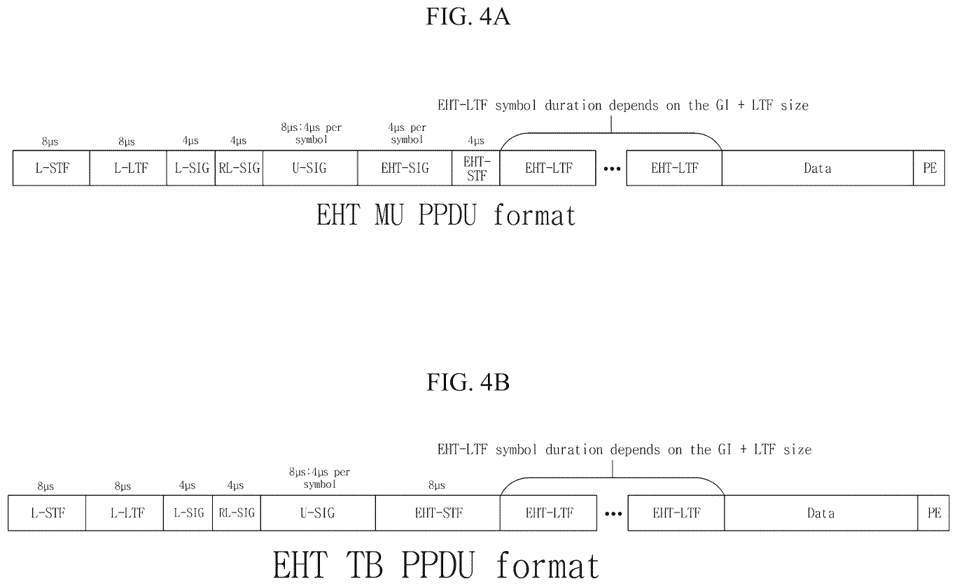

In EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A illustrates the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B illustrates the EHT TB PPDU format in accordance with an embodiment.

The EHT TB PPUD may be used for a transmission of a response to a triggering frame.

Referring to FIG. 4B, the EHT TB PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPUD, the EHT-SIG field is not present because the trigger frame conveys necessary information and the duration of the EHT_STF field in the EHT TB PPUD is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPUD, when the EHT modulated fields occupy more than one 20 MHz channels, the pre-EHT modulated fields may be duplicated over multiple 20 MHz channels.

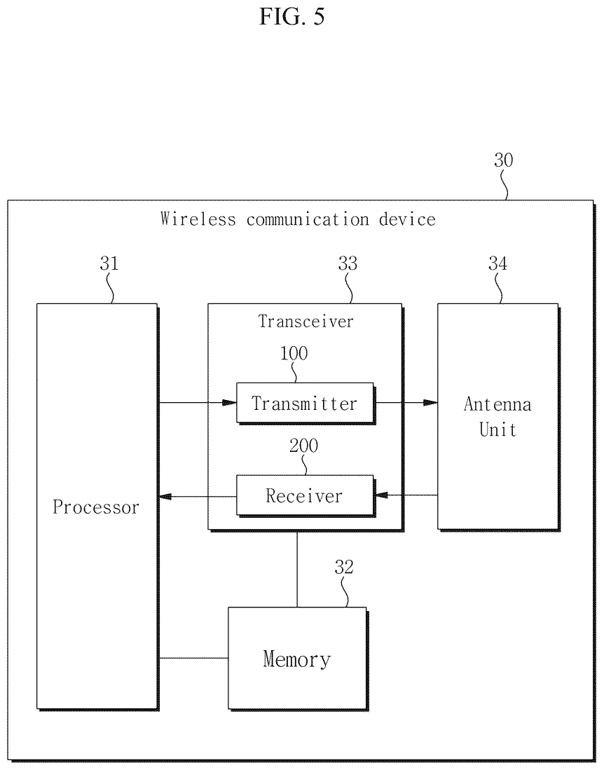

Hereinafter, electronic devices for facilitating wireless communication in accordance with various embodiments will be described with reference to FIG. 5.

FIG. 5 is a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In some embodiments, the processor 31 may comprise some or all of a transmitter 100 and a receiver 200. The processor 31 may be directly or indirectly coupled to the memory 32. In some embodiments, the processor 31 may include one or more processors.

The memory 32 may be non-transitory computer-readable recording medium storing instructions that, when executed by the processor 31, cause the electronic device 30 to perform operations, methods or procedures set forth in the present disclosure. In some embodiments, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

FIG. 6 shows a block diagram of a transmitter in accordance with an embodiment.

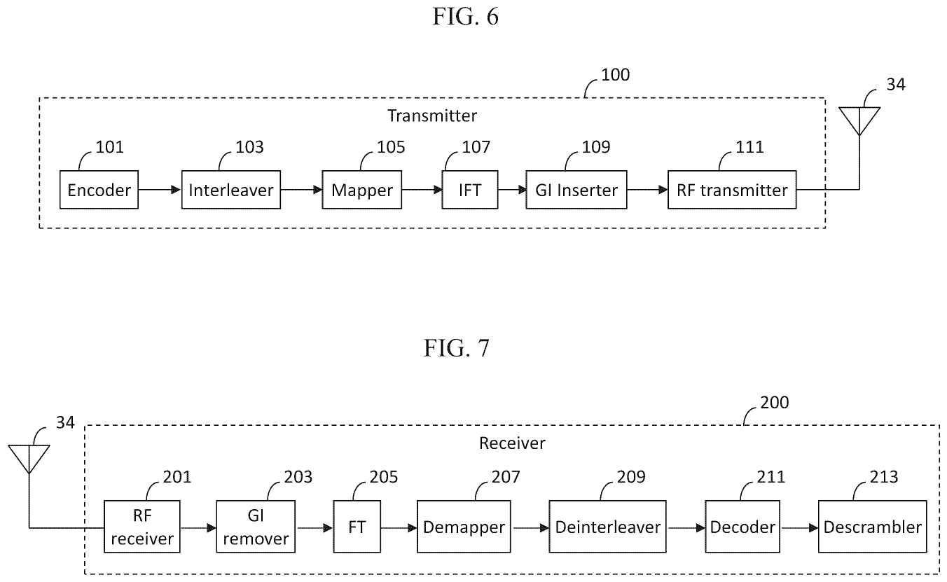

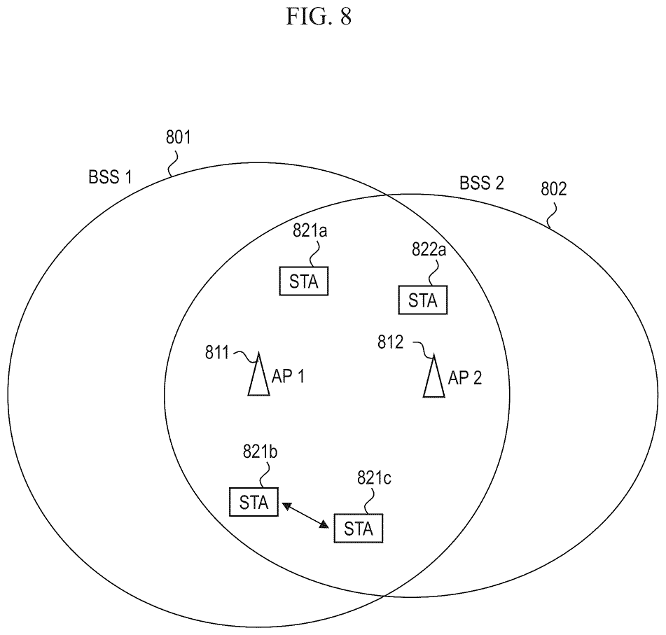

Referring to FIG. 7, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In some embodiments, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In some embodiments, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data.

The descrambler 213 may descramble the descrambled data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHz and 6 GHz.

There exists Wi-Fi technologies that allow a Wi-Fi device to connect to a single link and enable the Wi-Fi device to switch among 2.4 GHz, 5 GHz and 6 GHz bands. However, such Wi-Fi devices typically have a switching overhead or delay of up to 100 ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

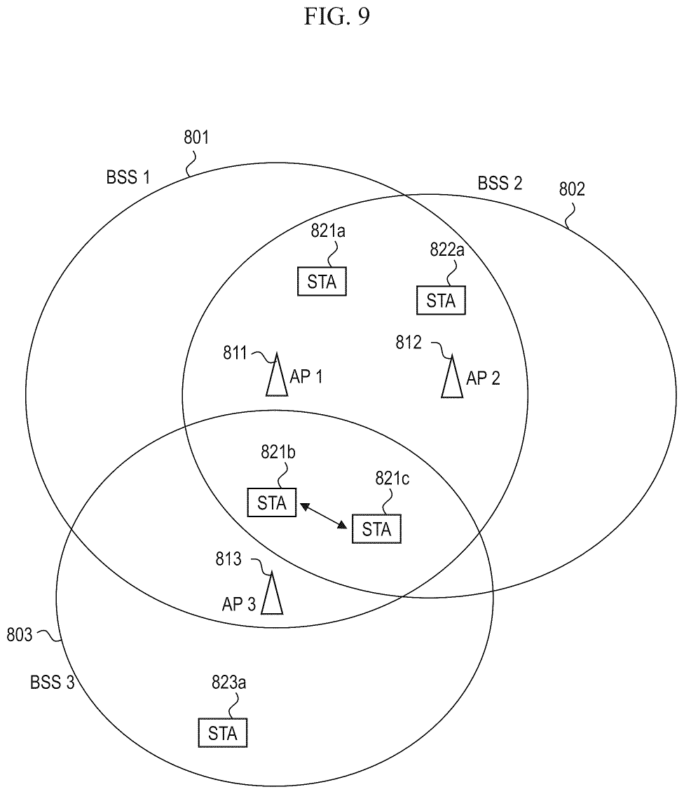

Hereinafter, network topologies in accordance with various embodiments will be described with reference to FIG. 8 and FIG. 9.

OBSS APs may exist around a specific AP. The OBSS APs may operate by coordinating with each other. For convenience, the AP which controls the coordination may be referred to as a sharing AP, and the AP which is controlled by the Sharing AP may be referred to as shared AP. Each of the sharing AP and the shared AP may form its own BSS and transmit and receive data with STAs associated with each AP.

FIG. 8 shows a network topology in accordance with an embodiment.

As shown in FIG. 8, an AP station 811 forms a BSS 801 and an AP station 812 forms a BSS 802. The AP station 811 is associated with non-AP stations 821a and 821b and the AP station 812 is associated with a non-AP station 822a. The AP station 811 and the AP station 812 operate as the sharing AP and the shared AP, respectively.

FIG. 9 shows a network topology in accordance with an embodiment.

Referring to FIG. 9, an AP station 813 and a non-AP station 823a are further involved in the network topology shown in FIG. 8. The AP station 813 forms a BSS 803 and is associated with the non-AP station 823a.

Unlike network topologies shown in FIG. 8 and FIG. 9, there may be more APs and more non-AP stations associated with each AP.

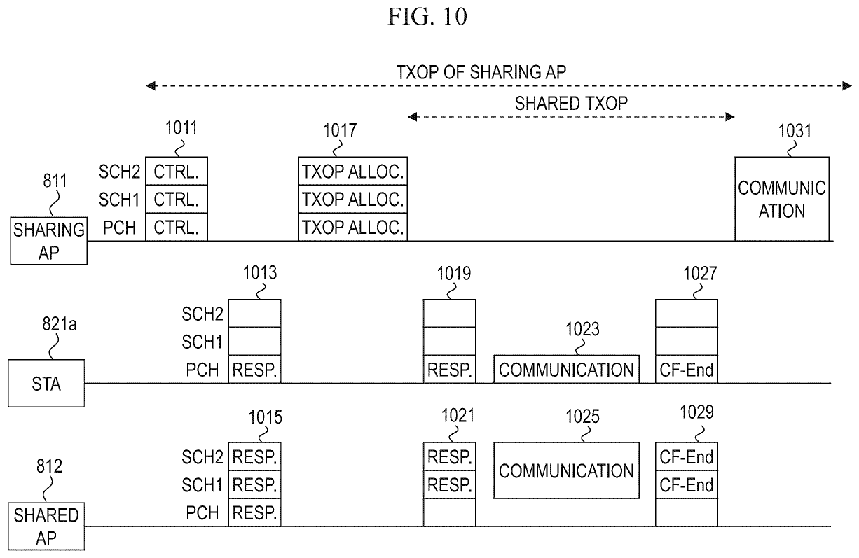

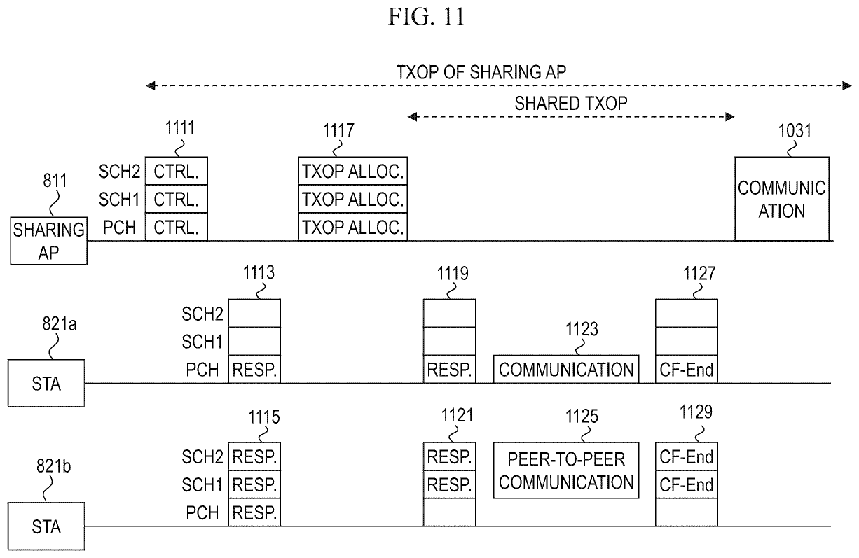

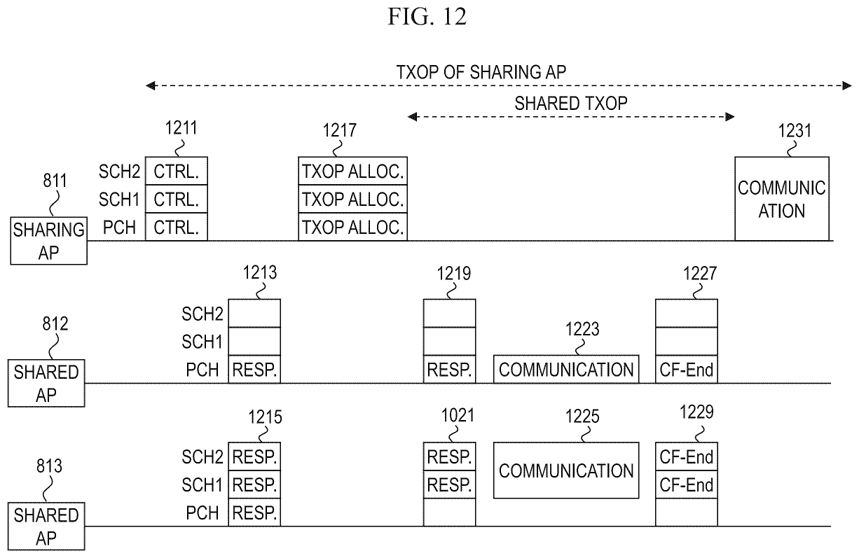

Hereinafter, channel-wise TXOP sharing procedures in accordance with various embodiments will be described with reference to FIG. 10, FIG. 11, and FIG. 12.

As embodiments, three cases for the enhanced TXOP sharing framework which is coordinated TDMA considering channel utilization by using channel-wise allocation will be described. In the first case, the sharing AP allocates time and frequency resources within the TXOP duration to a shared AP station and a non-AP station associated with the sharing AP. In the second case, the sharing AP allocates time and frequency resources within the TXOP duration to plural non-AP stations which are associated with the sharing AP. In the third case, the sharing AP allocates time and frequency resources within the TXOP duration to plural shared AP stations.

FIG. 10 shows a TXOP sharing procedure in accordance with an embodiment.

The embodiment of FIG. 10 may cover the detailed method by applying the topology example shown in FIG. 8. To describe the embodiment of FIG. 10, the AP 811 and the AP 812 will be referred to as the sharing AP 811 and the shared AP 812, respectively.

Referring to FIG. 10, a sharing AP 811 allocates time and frequency resources within the TXOP duration to a shared AP 812 and a non-AP station 821a associated with the sharing AP 811. In some embodiments, channels allocated to the shared AP 812 and the non-AP station 821a may be different.

When the sharing AP 811 obtains the TXOP, the sharing AP 811 transmits a control frame 1011 to the shared AP 812 and the non-AP station 821a. The shared AP 812 and the non-AP station 821a are the targets of TXOP sharing in the embodiment of FIG. 10. In some embodiments, the sharing AP 811 may transmit a MU-RTS frame as the control frame 1011. In some embodiments, the sharing AP 811 may transmit control frames 1011 in duplicate mode through idle channels after carrier sensing. A mode where a PHY transmission replicates a PHY protocol data unit two or more times over two or more channels may be referred to as a duplicate mode or a duplicated mode.

FIG. 10 shows an example where the primary channel, the secondary channel 1, and the secondary channel 2 are idle as a result of the carrier sensing of the sharing AP 811, and the sharing AP 811 transmits control frames 1011 through the three channels.

If the shared AP 812 and the non-AP station 821a receive the control frame 1011, they may transmit response frames 1013 and 1015 to the sharing AP 811 through the idle channel after carrier sensing. In some embodiments, the response frames 1013 and 1015 may be the CTS frame. In some embodiments, the shared AP 812 and the non-AP station 821a may determine the channels for transmitting the response frame from among the channels on which the control frames 1011 is received, and may transmit the response frames 1013 and 1015 in duplicated mode like the control frame 1011. In some embodiments, the shared AP 812 and the non-AP station 821a may inform how much traffic is currently accumulated in their buffers through the response frames 1013 and 1015. For example, the response frame 1013 may include buffer status information indicating how much traffic is currently accumulated in a buffer of the non-AP station 821a and the response frame 1015 may include buffer status information indicating how much traffic is currently accumulated in a buffer of the shared AP 812. In some embodiments, a control or management frame other than the CTS frame may be used as the response frames 1013 and 1015. The shared AP 812 and the non-AP station 821a may inform the available channels to which resources can be allocated by transmitting the response frame only through the idle channel.

Referring FIG. 10, the shared AP 812 determines that the primary channel, the secondary channel 1, and the secondary channel 2 all are idle and transmits response frames 1015 through these three channels. The non-AP station 821a determines that only the primary channel is idle and transmits the response frame 1013 through the primary channel.

If the sharing AP 811 receives the response frames 1013 and 1015 from the shared AP 812 and the non-AP station 821a, it may check which channels are idle on the shared AP 812, check which channels are idle channels for the non-AP station 821a, and check the buffer status of the shared AP 812 and the non-AP station 821a.

The sharing AP 811 transmits the TXOP allocation frames 1017 in duplicated mode through the channels on which the shared AP 812 and the non-AP station 821a transmits response frames 1013 and 1015. In some embodiments, the sharing AP 811 may allocate time and frequency resources within a portion of the TXOP based on buffer status among the idle channels of the shared AP 812 and the non-AP station 821a. In some embodiments, the sharing AP 811 may allocate more channels to the shared AP 812 or the non-AP station 821a which has more traffic in buffer.

In some embodiments, each of the TXOP allocation frames 1017 may include a plurality of TXOP allocation information elements. The plurality of TXOP allocation information elements may be associated with a respective one of a plurality of stations which transmit the response frames 1013 and 1015. The respective TXOP allocation information element may indicate a shared TXOP duration and one or more shared channels which the sharing AP 811 allocates to an associated station. The shared TXOP duration may be within a TXOP duration which the sharing AP 811 acquired and the one or more shared channels may be a subset of a plurality of channels for which the sharing AP station 811 acquired the TXOP.

In some embodiments, the sharing AP 811 may allocate channels to the shared AP 812 and the non-AP station 821a and the allocated channel to the shared AP 812 may not overlap with the allocated channel to the non-AP station 821a in the same shared TXOP duration. In this way, by assigning non-overlapping channels to the shared AP 812 and the non-AP station 821a, load balancing effects and latency reduction effects can be achieved.

Referring to FIG. 10, as the shared AP 812 and the non-AP station 821a transmit the response frames 1013 and 1015 on the primary channel, the secondary channel 1, and the secondary channel 2, the sharing AP 811 transmits the TXOP allocation frames 1017 to the shared AP 812 and the non-AP station 821a through the three channels. The sharing AP 811 may allocate the secondary channel 1 and the secondary channel 2 to the shared AP 812 and allocate the primary channel to the non-AP station 821a in the same shared TXOP duration.

If the shared AP 812 and the non-AP station 821a are allocated time and frequency resources within the TXOP through a TXOP allocation frame 1017 from the sharing AP 811, the shared AP 812 and the non-AP station 821a may transmit response frames 1019 and 1021 through the allocated channels to inform the sharing AP 811 that the shared AP 812 and the non-AP station 821a use the allocated time and frequency resources. In some embodiments, the CTS frame may be used as the response frames 1019 and 1021. Transmitting the response frames 1019 and 1021 may prevent interference caused by devices located in hidden nodes of the sharing AP 811.

Referring to FIG. 10, the shared AP 812 transmits a response frame 1021 through its allocated secondary channel 1 and the secondary channel 2, and the non-AP station 821a transmits a response frame 1119 through its allocated primary channel.

After the shared AP 812 transmits the response frame 1021, the shared AP 812 may transmit and receive data 1025 during the allocated time through the allocated channel with the non-AP station 822a with which the shared AP 812 is associated.

After the non-AP station 821a transmits the response frame 1019, the non-AP station 821a may transmit and receive data 1023 through the allocated channel during the allocated time with the sharing AP 811.

Referring to FIG. 10, the shared AP 812 transmits and receives data frames 1025 with associated STAs through the secondary channel 1 and the secondary channel 2 allocated to it, and the non-AP station 821a transmits and receives data frames 1023 with the sharing AP 811 through the primary channel allocated to it.

When the shared AP 812 and the non-AP station 821a complete data transmission and reception within the allocated time, they may return the remaining allocated time and frequency resources by sending a contention free end (CF-End) frame 1027 and 1029 to the sharing AP 811. Referring to FIG. 10, the shared AP 812 transmits CF-End frames 1029 on duplicate mode to the sharing AP 811 through the secondary channel 1 and the secondary channel 2, and the non-AP station 821a transmits the CF-End frame 1127 to the sharing AP 811 through the primary channel.

If the sharing AP 811 receives the CF-End frames 1027 and 1029 from the shared AP 812 and the non-AP station 821a, the sharing AP 811 may transmit and receive data 1031 during the remaining TXOP duration with the stations which the sharing AP 811 is associated with.

FIG. 11 shows a TXOP sharing procedure in accordance with an embodiment.

The embodiment of FIG. 11 may cover the detailed method by applying the topology example shown in FIG. 8. To describe the embodiment of FIG. 11, the AP 811 will be referred to as the sharing AP 811.

Referring to FIG. 11, the sharing AP 811 allocates time and frequency resources within the TXOP duration to the non-AP station 821a and the non-AP station 821b associated with the sharing AP 811. In some embodiments, channels allocated to the non-AP station 821a and the non-AP station 821b may be different. The embodiment of FIG. 11 may cover the detailed method by applying the topology example shown in FIG. 8.

When the sharing AP 811 obtains the TXOP, the sharing AP 811 transmits a control frame 1111 to the non-AP station 821a and the non-AP station 821b. The non-AP station 821a and the non-AP station 821b are the targets of TXOP sharing in the embodiment of FIG. 11. In some embodiments, the sharing AP 811 may transmit a MU-RTS frame as the control frame 1111. In some embodiments, the sharing AP 811 may transmit control frames 1111 in duplicated mode through idle channels after carrier sensing.

FIG. 11 shows an example where the primary channel, the secondary channel 1, and the secondary channel 2 are idle as a result of the carrier sensing of the sharing AP 811, and the sharing AP 811 transmits control frames 1111 through the three channels.

If the non-AP station 821a and the non-AP station 821b receive the control frame 1111, they may transmit response frames 1113 and 1115 to the sharing AP 811 through the idle channel after carrier sensing. In some embodiments, the response frames 1113 and 1115 may be the CTS frame. In some embodiments, the non-AP station 821a and the non-AP station 821b may determine the channels for transmitting the response frame from among the channels on which the control frames 1111 is received, and may transmit the response frames 1113 and 1115 in duplicated mode like the control frame 1111. In some embodiments, the non-AP station 821a and the non-AP station 821b may inform how much traffic is currently accumulated in their buffers through the response frames 1113 and 1115. For example, the response frame 1113 may include buffer status information indicating how much traffic is currently accumulated in a buffer of the non-AP station 821a and the response frame 1115 may include buffer status information indicating how much traffic is currently accumulated in a buffer of the non-AP station 821b. In some embodiments, a control or management frame other than the CTS frame may be used as the response frames 1113 and 1115. The non-AP station 821a and the non-AP station 821b may inform the available channels to which resources can be allocated by transmitting the response frame only through the idle channel.

Referring FIG. 11, the non-AP station 821a determines that only the primary channel is idle and transmits the response frame 1113 through the primary channel. The non-AP station 821b determines that the primary channel, the secondary channel 1, and the secondary channel 2 all are idle and transmits response frames 1115 through these three channels.

If the sharing AP 811 receives the response frames 1113 and 1115 from the non-AP station 821a and the non-AP station 821b, it may check which channels are idle on the non-AP station 821a, check which channels are idle channels for the non-AP station 821b, and check the buffer status of the non-AP station 821a and the non-AP station 821b.

The sharing AP 811 transmits the TXOP allocation frames 1117 in duplicated mode through the channels on which the non-AP station 821a and the non-AP station 821b transmits response frames 1113 and 1115. In some embodiments, the sharing AP 811 may allocate time and frequency resources within a portion of the TXOP based on buffer status among the idle channels of the non-AP station 821a and the non-AP station 821b. In some embodiments, the sharing AP 811 may allocate more channels to the non-AP station 821a or the non-AP station 821b which has more traffic in buffer.

In some embodiments, each of the TXOP allocation frames 1117 may include a plurality of TXOP allocation information elements. The plurality of TXOP allocation information elements may be associated with a respective one of a plurality of stations which transmit the response frames 1113 and 1115. The respective TXOP allocation information element may indicate a shared TXOP duration and one or more shared channels which the sharing AP 811 allocates to an associated station. The shared TXOP duration may be within a TXOP duration which the sharing AP 811 acquired and the one or more shared channels may be a subset of a plurality of channels for which the sharing AP station 811 acquired the TXOP.

In some embodiments, the sharing AP 811 may allocate channels to the non-AP station 821a and the non-AP station 821b and the allocated channel to the non-AP station 821a may not overlap with the allocated channel to the non-AP station 821b in the same shared TXOP duration. In this way, by assigning non-overlapping channels to the non-AP station 821a and the non-AP station 821b, load balancing effects and latency reduction effects can be achieved.

Referring to FIG. 11, as the non-AP station 821a and the non-AP station 821b transmit the response frames 1113 and 1115 on the primary channel, the secondary channel 1, and the secondary channel 2, the sharing AP 811 transmits the TXOP allocation frames 1117 to the non-AP station 821a and the non-AP station 821b through the three channels. The sharing AP 811 may allocate the secondary channel 1 and the secondary channel 2 to the non-AP station 821b and allocate the primary channel to the non-AP station 821a in the same shared TXOP duration.

If the non-AP station 821a and the non-AP station 821b are allocated time and frequency resources within the shared portion of the TXOP duration through a TXOP allocation frame 1117 from the sharing AP 811, the non-AP station 821a and the non-AP station 821b may transmit response frames 1119 and 1121 through the allocated channels to inform the sharing AP 811 that the non-AP station 821a and the non-AP station 821b use the allocated time and frequency resources. In some embodiments, the CTS frame may be used as the response frames 1119 and 1121. Transmitting the response frames 1119 and 1121 may prevent interference caused by devices located in hidden nodes of the sharing AP 811.

Referring to FIG. 11, the non-AP station 821a transmits a response frame 1119 through its allocated primary channel, and the non-AP station 821b transmits a response frame 1121 through its allocated secondary channel 1 and the secondary channel 2.

After the non-AP station 821a transmits the response frame 1119, the non-AP station 821a may exchange data 1123 through the allocated channel during the allocated time with the sharing AP 811.

After the non-AP station 821b transmits the response frame 1121, without relying on any AP stations, the non-AP station 821b may perform peer-to-peer communication 1025 directly with the non-AP station 821c in the same BSS, during the allocated time through the allocated channel.

Referring to FIG. 11, the non-AP station 821a transmits and receives data frames 1123 to/from the sharing AP 811 through the primary channel allocated to it. The non-AP station 821b transmits and receives data frames 1125 with the non-AP station 821c in peer-to-peer communication through the secondary channel 1 and the secondary channel 2 allocated to it.

When the non-AP station 821a and the non-AP station 821b complete data transmission and reception within the allocated time, they may return the remaining allocated time and frequency resources by sending a contention free end (CF-End) frame 1127 and 1129 to the sharing AP 811. Referring to FIG. 11, the non-AP station 821a transmits CF-End frames 1127 on duplicate mode to the sharing AP 811 through the secondary channel 1 and the secondary channel 2, and the non-AP station 821b transmits the CF-End frame 1129 to the sharing AP 811 through the primary channel.

If the sharing AP 811 receives the CF-End frames 1127 and 1129 from the non-AP station 821b and the non-AP station 821a, the sharing AP 811 may transmit and receive data 1131 during the remaining TXOP duration with the stations which the sharing AP 811 is associated with.

FIG. 12 shows a TXOP sharing procedure in accordance with an embodiment.

The embodiment of FIG. 12 may cover the detailed method by applying the topology example shown in FIG. 9. To describe the embodiment of FIG. 12, the AP 811, the AP 812, and the AP 813 will be referred to as the sharing AP 811, the shared AP 812, and the shared 813, respectively. In some embodiments, the shared AP 812 and shared AP 813 ma be hearable from the sharing AP 811.

Referring to FIG. 12, the sharing AP 811 allocates time and frequency resources within the TXOP duration to the shared AP 812 and the shared AP 813 associated with the sharing AP 811. In some embodiments, channels allocated to the shared AP 812 and the shared AP 813 may be different.

When the sharing AP 811 obtains the TXOP, the sharing AP 811 transmits a control frame 1211 to the shared AP 812 and the shared AP 813. The shared AP 812 and the shared AP 813 are the targets of TXOP sharing in the embodiment of FIG. 12. In some embodiments, the sharing AP 811 may transmit a MU-RTS frame as the control frame 1211. In some embodiments, the sharing AP 811 may transmit control frames 1211 in duplicated mode through idle channels after carrier sensing.

FIG. 12 shows an example where the primary channel, the secondary channel 1, and the secondary channel 2 are idle as a result of the carrier sensing of the sharing AP 811, and the sharing AP 811 transmits control frames 1211 through the three channels.

If the shared AP 812 and the shared AP 813 receive the control frame 1211, they may transmit response frames 1213 and 1215 to the sharing AP 811 through the idle channel after carrier sensing. In some embodiments, the response frames 1213 and 1215 may be the CTS frame. In some embodiments, the shared AP 812 and the shared AP 813 may determine the channels for transmitting the response frame from among the channels on which the control frames 1211 is received, and may transmit the response frames 1213 and 1215 in duplicated mode like the control frame 1211. In some embodiments, the shared AP 812 and the shared AP 813 may inform how much traffic is currently accumulated in their buffers through the response frames 1213 and 1215. For example, the response frame 1213 may include buffer status information indicating how much traffic is currently accumulated in a buffer of the shared AP 812 and the response frame 1215 may include buffer status information indicating how much traffic is currently accumulated in a buffer of the shared AP 813. In some embodiments, a control or management frame other than the CTS frame may be used as the response frames 1213 and 1215. The shared AP 812 and the shared AP 813 may inform the available channels to which resources can be allocated by transmitting the response frame only through the idle channel.

Referring FIG. 12, the shared AP 812 determines that only the primary channel is idle and transmits the response frame 1213 through the primary channel. The shared AP 813 determines that the primary channel, the secondary channel 1, and the secondary channel 2 all are idle and transmits response frames 1215 through these three channels.

If the sharing AP 811 receives the response frames 1213 and 1215 from the shared AP 812 and the shared AP 813, it may check which channels are idle on the shared AP 812, check which channels are idle channels for the shared AP 813, and check the buffer status of the shared AP 812 and the shared AP 813.

The sharing AP 811 transmits the TXOP allocation frames 1217 in duplicated mode through the channels on which the shared AP 812 and the shared AP 813 transmits response frames 1213 and 1215. In some embodiments, the sharing AP 811 may allocate time and frequency resources within a portion of the TXOP based on buffer status among the idle channels of the shared AP 812 and the shared AP 813. In some embodiments, the sharing AP 811 may allocate more channels to the shared AP 812 or the shared AP 813 which has more traffic in buffer.

In some embodiments, each of the TXOP allocation frames 1217 may include a plurality of TXOP allocation information elements. The plurality of TXOP allocation information elements may be associated with a respective one of a plurality of stations which transmit the response frames 1213 and 1215. The respective TXOP allocation information element may indicate a shared TXOP duration and one or more shared channels which the sharing AP 811 allocates to an associated station. The shared TXOP duration may be within a TXOP duration which the sharing AP 811 acquired and the one or more shared channels may be a subset of a plurality of channels for which the sharing AP station 811 acquired the TXOP.

In some embodiments, the sharing AP 811 may allocate channels to the shared AP 812 and the shared AP 813 and the allocated channel to the shared AP 812 may not overlap with the allocated channel to the shared AP 813 in the same shared TXOP duration. In this way, by assigning non-overlapping channels to the shared AP 812 and the shared AP 813, load balancing effects and latency reduction effects can be achieved.

Referring to FIG. 12, as the shared AP 812 and the shared AP 813 transmit the response frames 1213 and 1215 on the primary channel, the secondary channel 1, and the secondary channel 2, the sharing AP 811 transmits the TXOP allocation frames 1217 to the shared AP 812 and the shared AP 813 through the three channels. The sharing AP 811 may allocate the secondary channel 1 and the secondary channel 2 to the shared AP 813 and allocate the primary channel to the shared AP 812 in the same shared TXOP duration.

If the shared AP 812 and the shared AP 813 are allocated time and frequency resources within the shared portion of the TXOP duration through a TXOP allocation frame 1217 from the sharing AP 811, the shared AP 812 and the shared AP 813 may transmit response frames 1219 and 1221 through the allocated channels to inform the sharing AP 811 that the shared AP 812 and the shared AP 813 use the allocated time and frequency resources. In some embodiments, the CTS frame may be used as the response frames 1219 and 1221. Transmitting the response frames 1219 and 1221 may prevent interference caused by devices located in hidden nodes of the sharing AP 811.

Referring to FIG. 12, the shared AP 812 transmits a response frame 1219 through its allocated primary channel, and the shared AP 813 transmits a response frame 1221 through its allocated secondary channel 1 and the secondary channel 2.

After the shared AP 812 transmits the response frame 1219, the shared AP 812 may perform wireless communication 1223 with the non-AP stations with which the shared AP 812 is associated with, through the allocated channel during the allocated time.

After the shared AP 813 transmits the response frame 1221, the shared AP 813 may perform wireless communication 1225 with the non-AP stations with which the shared AP 813 is associated with, during the allocated time through the allocated channel.

Referring to FIG. 12, the shared AP 812, through the primary channel, transmits and receives data frames 1223 to/from one or more non-AP stations with which the shared AP 812 is associated. The shared AP 813, through the secondary channel 1 and the secondary channel 2, transmits and receives data frames 1225 to/from tone or more non-AP stations with which the shared AP 813 is associated.

When the shared AP 812 and the shared AP 813 complete wireless communication within the allocated time, they may return the remaining allocated time and frequency resources by sending a contention free end (CF-End) frame 1227 and 1229 to the sharing AP 811. Referring to FIG. 12, the shared AP 812 transmits CF-End frames 1227 on duplicate mode to the sharing AP 811 through the secondary channel 1 and the secondary channel 2, and the shared AP 813 transmits the CF-End frame 1229 to the sharing AP 811 through the primary channel.

If the sharing AP 811 receives the CF-End frames 1227 and 1229 from the shared AP 813 and the shared AP 812, the sharing AP 811 may transmit and receive data 1231 during the remaining TXOP duration with the stations which the sharing AP 811 is associated with.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A wireless communication device for facilitating wireless communication, comprising processing circuitry configured to cause:
receiving, from a sharing access point (AP) station, a transmission opportunity (TXOP) allocation frame including information indicating a first shared duration of a TXOP and one or more first shared channels which the sharing AP station allocates to the wireless communication device, wherein the first shared duration of the TXOP is within a duration of the TXOP acquired by the sharing AP station and the one or more first shared channels are a subset of a plurality of channels for which the sharing AP station acquired the TXOP; and
performing wireless communication using the one or more first shared channels in the first shared duration of the TXOP.

2. The wireless communication device of claim 1, wherein the TXOP allocation frame further includes information indicating a second shared duration of the TXOP and one or more second shared channels which the sharing AP station allocates to another wireless communication device, wherein the second shared duration of the TXOP is the same as the first shared duration of the TXOP and the one or more second shared channels are not overlapped with the one or more first shared channels.

3. The wireless communication device of claim 2, wherein the wireless communication device is a non-AP station which is associated with the sharing AP station, and the another wireless communication device is an AP station.

4. The wireless communication device of claim 2, wherein the wireless communication device is an AP station, and the another wireless communication device is a non-AP station which is associated with the sharing AP station.

5. The wireless communication device of claim 2, wherein the wireless communication device is a first non-AP station which is associated with the sharing AP station, and the another wireless communication device is a second non-AP station which is associated with the sharing AP station.

6. The wireless communication device of claim 2, wherein the wireless communication device is a first AP station, and the another wireless communication device is a second AP station.

7. The wireless communication device of claim 1, wherein the processing circuitry is further configured to cause:
transmitting a response frame in response to the TXOP allocation frame using the one or more first shared channels.

8. The wireless communication device of claim 1, wherein the processing circuitry is further configured to cause:
receiving a control frame, wherein the control frame is transmitted through the plurality of channels by the sharing AP station after the sharing AP station acquires the TXOP;
determining one or more idle channels among the plurality of channels; and
transmitting a response frame through the one or more idle channels in response to the control frame,
wherein the one or more first shared channels is all or a subset of the one or more idle channels.

9. The wireless communication device of claim 8, wherein the response frame includes buffer status information of the wireless communication device.

10. The wireless communication device of claim 8, wherein multi-user request to send (MU-RTS) frames are transmitted on duplicate mode through the plurality of channels as the control frame, and the clear to send (CTS) frame is transmitted on duplicate mode through the one or more idle channels as the response frame.

11. The wireless communication device of claim 1, wherein the processing circuitry is further configured to cause:
transmitting, to the sharing AP station, a frame to return the first shared duration of the TXOP and the one or more first shared channels.

12. The wireless communication device of claim 1, wherein the wireless communication device is a non-AP station, and
wherein performing the wireless communication comprises:
performing wireless communication with the sharing AP station using the one or more first shared channels in the first shared duration of the TXOP.

13. The wireless communication device of claim 1, wherein the wireless communication device is an AP station, and
wherein performing the wireless communication comprises:
performing wireless communication with one or more associated non-AP stations using the one or more first shared channels in the first shared duration of the TXOP.

14. The wireless communication device of claim 1, wherein the wireless communication device is a non-AP station, and
wherein performing the wireless communication comprises:
performing peer-to-peer wireless communication with one or more non-AP stations using the one or more first shared channels in the first shared duration of the TXOP.

15. An access point (AP) station for facilitating wireless communication, comprising processing circuitry configured to cause:
acquiring a transmission opportunity (TXOP) for a plurality of channels; and
transmitting a TXOP allocation frame including information indicating a first shared duration of the TXOP and one or more first shared channels which the AP station allocates to a first wireless communication device, wherein the first shared duration of the TXOP is within a duration of the TXOP acquired by the AP station and the one or more first shared channels are a subset of the plurality of channels for which the AP station acquired the TXOP,
wherein the TXOP allocation frame enables the first wireless communication device to perform wireless communication using the one or more first shared channels in the first shared duration of the TXOP.

16. The AP station of claim 15, wherein the TXOP allocation frame further includes information indicating a second shared duration of the TXOP and one or more second shared channels which the AP station allocates to a second wireless communication device, wherein the second shared duration of the TXOP is the same as the first shared duration of the TXOP and the one or more second shared channels are not overlapped with the one or more first shared channels.

17. The AP station of claim 15, wherein the processing circuitry is further configured to cause:
receiving, from the first wireless communication device, a response frame in response to the TXOP allocation frame using the one or more first shared channels.

18. The AP station of claim 15, wherein the processing circuitry is further configured to cause:
transmitting a control frame through the plurality of channels by the AP station after the AP station acquires the TXOP; and
receiving a response frame from the first wireless communication device through one or more idle channels of the first wireless communication device in response to the control frame,
wherein the one or more first shared channels is all or a subset of the one or more idle channels.

19. The AP station of claim 18, wherein the response frame includes buffer status information of the wireless communication device.

20. The AP station of claim 18, wherein multi-user request to send (MU-RTS) frames are transmitted on duplicate mode through the plurality of channels as the control frame, and the clear to send (CTS) frame is transmitted on duplicate mode through the one or more idle channels as the response frame.
